(19) United States
(12) Patent Application Publication
(10) Pub. No.: US 2015/0077001 A1
(43) Pub. Date: Mar. 19, 2015

(54) LIGHTING SOURCE AND LIGHTING APPARATUS

(71) Applicant: PANASONIC CORPORATION, Osaka (JP)

(72) Inventors: Akira TAKAHASHI, Osaka (JP); Kazuhiro TAKEDA, Osaka (JP)

(21) Appl. No.: 14/458,493

(22) Filed: Aug. 13, 2014

(30) Foreign Application Priority Data
Sep. 13, 2013 (JP) 2013-190978

(51) Int. Cl. H05B 33/08

(52) U.S. Cl. CPC H05B 33/0815; H05B 33/0857
USPC 315/193

(57) ABSTRACT

A straight tube LED lamp according to one aspect of the present invention includes: a first LED array including first LED elements connected in series; a second LED array that includes second LED elements connected in series, and emits light having a different emission color from an emission color of the first LED array; a FET switch provided in a path through which current flows to the second LED array; and a constant power output circuit that outputs power without changing a total value of the power, wherein the number of the first LED elements connected in series is greater than the number of the second LED elements connected in series, a total forward voltage of the first LED array is greater than a total forward voltage of the second LED array, and the first LED elements are in alignment with the second LED elements.

### CROSS REFERENCE TO RELATED APPLICATION

This application claims the benefit of priority of Japanese Patent Application Number 2013-190978, filed Sep. 13, 2013, the entire content of which is hereby incorporated by reference.

### TECHNICAL FIELD

The disclosure relates to a lighting source including light-emitting elements such as light-emitting diodes (LEDs), and to a lighting apparatus including the lighting source.

### BACKGROUND ART

In recent years, a lighting apparatus using a light-emitting module including semiconductor light-emitting elements such as LEDs has gained in popularity as a substitute for an incandescent light bulb. In general, a change in level of current flowing through an LED chip does not change the emission color of the LED chip. This is because the emission color of the LED chip depends on the bandgap of a semiconductor material included in the LED chip, but does not depend on the current level.

In view of the above, Patent Literature (PTL) 1 (Japanese Unexamined Patent Application Publication No. 2009-09782) discloses an LED module which is capable of changing the emission color in the use of the LEDs.

FIG. 10 is a circuit diagram of a conventional LED module disclosed in PTL 1. As shown in FIG. 10, the LED module 900 includes a red LED array 921 and a white LED array 922 which are connected in parallel. The red LED array 921 includes red LEDs 921a, 921b, 921c, . . . , 921d, 921e, and 921f which are connected in series. The white LED array 922 includes white LEDs 922a, 922b, . . . , 922c, and 922d which are connected in series. The white LED array 922 is connected in series to a bipolar transistor 924 and a resistive element 926. The bipolar transistor 924 has a base terminal connected to a variable voltage source 927 via a resistive element 925. Furthermore, the bipolar transistor 924 has a collector terminal connected to the cathode terminal of the white LED 922d, and an emitter terminal connected to the resistive element 926.

The LED module 900 is connected to a variable current source 933. Alternating-current (AC) power supplied from an AC source 931 undergoes AC to DC conversion performed by an AC/DC converter 932, and the resulting power is supplied to the variable current source 933. Accordingly, current is supplied to the LED module 900 from the variable current source 933.

The LED module 900 is capable of changing base current by changing base-emitter voltage of the bipolar transistor 924. Here, the collector current increases as the base current of the bipolar transistor 924 increases. This leads to an increase in current flowing through the white LED array 922. By increasing the current flowing through the white LED array 922 among the current supplied from the variable current source 933, the current flowing through the red LED array 921 relatively decreases. As a result, the emission color of the LED module 900 approaches white. On the other hand, by reducing the current flowing through the white LED array 922, the current flowing through the red LED array 921 relatively increases. As a result, the emission color of the LED module 900 approaches orange.

### SUMMARY

The LED module disclosed in PTL 1, however, has a configuration for changing the emission color of the LED module 900 according to light adjustment, and is incapable of switching between only the emission colors without changing brightness and power consumption.

The present invention has been conceived in view of the above problem, and an object of the present invention is to provide a lighting source and a lighting apparatus that are capable of switching between emission colors without changing the brightness and the power consumption.

In order to achieve the above object, a lighting source according to one aspect of the present invention includes: an elongated board; a first light-emitting unit including a plurality of first light-emitting elements aligned on the elongated board in a longitudinal direction thereof and electrically connected in series; a second light-emitting unit including a plurality of second light-emitting elements aligned on the elongated board in the longitudinal direction, electrically connected in series, and emitting light having an emission color different from an emission color of the first light-emitting unit; a first switch element provided in a second current path among a first current path and the second current path, the first current path being a path through which current flows to the first light-emitting unit, and the second current path being a path through which current flows to the second light-emitting unit; and a constant power output circuit that outputs power to the first light-emitting unit and the second light-emitting unit without changing a total value of the power supplied to the first light-emitting unit and the second light-emitting unit between before and after conduction and non-conduction of the first switch element are switched, wherein the number of the plurality of first light-emitting elements connected in series is greater than the number of the plurality of second light-emitting elements connected in series, a first total forward voltage is greater than a second total forward voltage, the first total forward voltage being a voltage value obtained by adding a forward voltage of each and every one of the plurality of first light-emitting elements connected in series, and the second total forward voltage being a voltage value obtained by adding a forward voltage of each and every one of the plurality of second light-emitting elements, and the plurality of first light-emitting elements are in alignment with the plurality of second light-emitting elements.

Moreover, in the lighting source according to another aspect of the present invention, at least one of the plurality of first light-emitting elements may be disposed between two light-emitting elements arbitrarily selected from among the plurality of second light-emitting elements.

Furthermore, in the lighting source according to another aspect of the present invention, the forward voltage of each of the plurality of first light-emitting elements may be equal to the forward voltage of each of the plurality of second light-emitting elements, each of the plurality of first light-emitting elements and each of the plurality of second light-emitting elements may include, on respective surfaces thereof, phosphors different from each other, and the first light-emitting unit may have lower luminous efficiency than the second light-emitting unit does.

Moreover, in the lighting source according to another aspect of the present invention, an amount of light emission of the first light-emitting unit may be equal to an amount of light emission of the second light-emitting unit.

Furthermore, in the lighting source according to another aspect of the present invention, the first switch element may be connected in series either one of between a first anode terminal of the first light-emitting unit and a second anode terminal of the second light-emitting unit and between a first cathode terminal of the first light-emitting unit and a second cathode terminal of the second light-emitting unit, and the constant power output circuit may have a negative output terminal connected to the first cathode terminal and either one of the second cathode terminal and the first switch element connected to the second cathode terminal, and a positive output terminal connected to the first anode terminal and either one of the second anode terminal and the first switch element connected to the second anode terminal.

Moreover, in the lighting source according to another aspect of the present invention, the first current path may bypass the first switch element, the second current path may pass through the first switch element, if the first switch element is in a non-conduction state, the constant power output circuit may supply the power only to the first light-emitting unit among the first light-emitting unit and the second light-emitting unit, and if the first switch element is in a conduction state, the constant power output circuit may supply main power to the second light-emitting unit.

Furthermore, in the lighting source according to another aspect of the present invention, the first total forward voltage and the second total forward voltage may have a difference of at least 4 V, and if the first switch element is in the conduction state, the constant power output circuit may supply the power only to the second light-emitting unit among the first light-emitting unit and the second light-emitting unit.

Moreover, in the lighting source according to another aspect of the present invention, the first total forward voltage and the second total forward voltage may have a difference of at least 2 V but less than 4 V, and if the first switch element is in the conduction state, the constant power output circuit may supply the main power to the second light-emitting unit, and power less than the main power to the first light-emitting unit.

Furthermore, in the lighting source according to another aspect of the present invention, the constant power output circuit may include: an inductor that is connected in parallel to the first light-emitting unit and in parallel to a series-connected portion of the second light-emitting unit and the first switch element; a second switch element connected in series to the inductor between a positive input terminal and a negative input terminal of the constant power output circuit; and an oscillation control unit configured to control conduction and non-conduction of the second switch element, if the second switch element is in a conduction state, the inductor may be charged with current flowing from a power source to the inductor, and if the second switch element is in a non-conduction state, magnetic energy stored in the inductor by the charging may be released to either one of the first light-emitting unit and the second light-emitting unit.

Moreover, in the lighting source according to another aspect of the present invention, the first light-emitting unit may have an emission color that is incandescent color, and the second light-emitting unit may have an emission color that is daylight color.

Furthermore, a lighting apparatus according to another aspect of the present invention includes the lighting source described above.

According to a lighting source and a lighting apparatus of an embodiment of the present invention, since, among light-emitting units each having a different emission color, a light-emitting unit having a greater number of light-emitting elements connected in series has a greater total forward voltage, a first switch element switches between current paths of the light-emitting units, and a constant power output circuit supplies constant power, it is possible to switch between emission colors without changing brightness and power consumption. Moreover, the light-emitting elements included in each of two light-emitting units are aligned, and thus it is possible to switch between the emission colors without changing light distribution properties. Therefore, an optical mechanism for adjusting the light distribution properties can be simplified.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a general perspective view of a straight tube LED lamp according to Embodiment 1.

FIG. 2 is a cross-sectional view in a tube axis direction of the straight tube LED lamp according to Embodiment 1.

FIG. 3 is a perspective view illustrating a configuration of an LED module according to Embodiment 1.

FIG. 4 is an exemplary layout view of LED elements in the LED module according to Embodiment 1.

FIG. 5 is a block configuration diagram of an LED lamp according to Embodiment 1.

FIG. 6A is a state transition diagram illustrating a current path in the case where a FET switch of the LED lamp according to Embodiment 1 is in the ON state.

FIG. 6B is a state transition diagram illustrating a current path in the case where the FET switch of the LED lamp according to Embodiment 1 is in the OFF state.

FIG. 7 is a circuit configuration diagram including the LED lamp according to Embodiment 1.

FIG. 8 is a circuit configuration diagram including an LED lamp according to a modification of Embodiment 1.

FIG. 9 is a general perspective view of a lighting apparatus according to Embodiment 2.

FIG. 10 is a circuit diagram of a conventional LED module disclosed in PTL 1.

FIG. 11 is a diagram illustrating a configuration of a conventional lighting source capable of switching between emission colors.

### DETAILED DESCRIPTION

### (Underlying Knowledge Forming Basis of the Present Invention)

In relation to the conventional LED lamp disclosed in the Background Art section, the inventors have found the following problem.

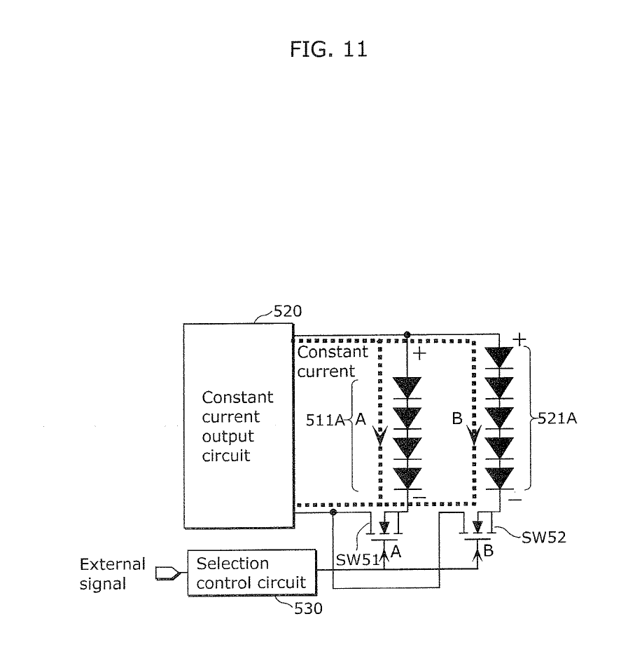

The LED module disclosed in PTL 1 has a configuration for changing the emission color of the LED module 900 according to light adjustment, and is incapable of switching between only the emission colors without changing brightness and power consumption. In contrast, a configuration of a lighting source as illustrated in FIG. 11 is given as a lighting source capable of switching between emission colors without light adjustment.

FIG. 11 is a diagram illustrating the configuration of the conventional lighting source capable of switching between emission colors. The conventional lighting source illustrated in FIG. 11 includes LED arrays 511A and 521A, FET switches SW51 and SW52, a constant current output circuit 520, and a selection control circuit 530. The LED arrays 511A and 521A each are an array having LEDs connected in series, and have a different emission color. The constant current output circuit 520 is a back converter, for instance, and passes a constant current through one of the LED arrays 511A and 521A if the selection control circuit 530 switches between paths in each of which the constant current flows. In the above configuration, to switch between the emission colors, that is, to switch a current path from one of the LED arrays 511A and 521A to the other of the LED arrays 511A and 521A, it is necessary to exclusively switch between ON and OFF of the FET switches SW51 and SW52 respectively provided in wiring lines of the LED arrays 511A and 521A.

Unfortunately, the following problem occurs if the emission color is switched in the above configuration using the constant current output circuit 520. In general, as a method for making the emission color of each of the LED arrays 511A and 521A different, the emission color is changed by making, while the LED arrays 511A and 521A have the same chip specification, phosphors on the chips different. In this case, the problem occurs that brightness changes when the current path is switched due to a difference in efficiency of the phosphors even if the LED arrays 511A and 521A have the same number of the chips and a constant current is passed. Moreover, if the numbers of the chips of the LED arrays 511A and 521A are varied to prevent the variation in the brightness, the LED arrays 511A and 521A have the same current but differ in generated voltage. If the constant current is passed from the constant current output circuit 520 in this configuration, the problem occurs that the power consumption varies.

In order to solve such a problem, a lighting source according to one aspect of the present invention includes: an elongated board; a first light-emitting unit including a plurality of first light-emitting elements aligned on the elongated board in a longitudinal direction thereof and electrically connected in series; a second light-emitting unit including a plurality of second light-emitting elements aligned on the elongated board in the longitudinal direction, electrically connected in series, and emitting light having an emission color different from an emission color of the first light-emitting unit; a first switch element provided in a second current path among a first current path and the second current path, the first current path being a path through which current flows to the first light-emitting unit, and the second current path being a path through which current flows to the second light-emitting unit; and a constant power output circuit that outputs power to the first light-emitting unit and the second light-emitting unit without changing a total value of the power supplied to the first light-emitting unit and the second light-emitting unit between before and after conduction and non-conduction of the first switch element are switched, wherein the number of the plurality of first light-emitting elements connected in series is greater than the number of the plurality of second light-emitting elements connected in series, a first total forward voltage is greater than a second total forward voltage, the first total forward voltage being a voltage value obtained by adding a forward voltage of each and every one of the plurality of first light-emitting elements connected in series, and the second total forward voltage being a voltage value obtained by adding a forward voltage of each and every one of the plurality of second light-emitting elements, and the plurality of first light-emitting elements are in alignment with the plurality of second light-emitting elements.

According to this aspect, since, among the light-emitting units each having the different emission color, a light-emitting unit having a greater number of light-emitting elements connected in series has a greater total forward voltage, the first switch element switches between the current paths of the light-emitting units, and the constant power output circuit supplies constant power, it is possible to switch between the emission colors without changing brightness and power consumption. Moreover, the light-emitting elements included in each of two light-emitting units are aligned, and thus it is possible to switch between the emission colors without changing light distribution properties. Therefore, an optical mechanism for adjusting the light distribution properties can be simplified.

Hereinafter, a lighting source and a lighting apparatus according to embodiments of the present invention are described with reference to the drawings. Each of the embodiments to be described below shows a specific example of the present invention. The numerical values, shapes, materials, structural elements, the arrangement and connection of the structural elements, etc. shown in the following embodiments are mere examples, and therefore do not limit the scope of the present invention. Therefore, among the structural elements in the following embodiments, structural elements not recited in any one of the independent claims are described as arbitrary structural elements.

It is to be noted that each of the drawings is a schematic diagram, and is not strictly illustrated. Moreover, the same reference signs are assigned to the same structural elements in each drawing.

### Embodiment 1

First, a straight tube LED lamp 1 according to Embodiment 1 of the present invention is described. It is to be noted that the straight tube LED lamp 1 according to this embodiment substitutes for a conventional straight tube fluorescent lamp.

### [Entire Configuration of Lamp]

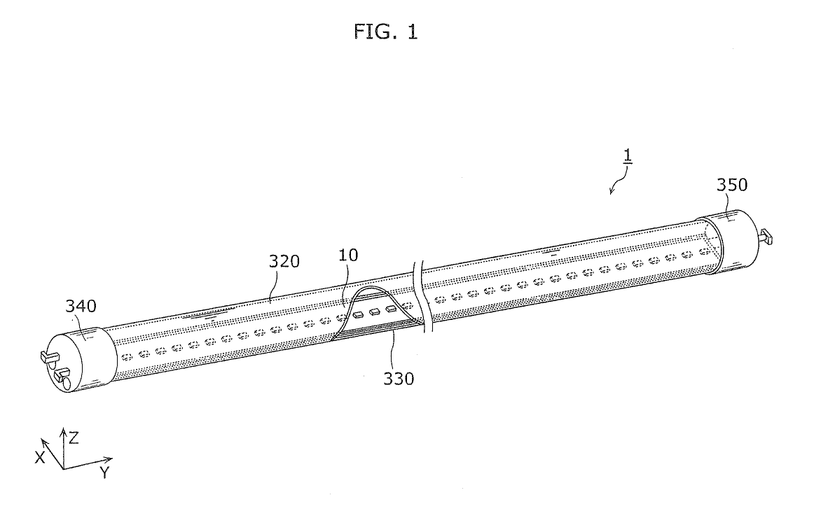

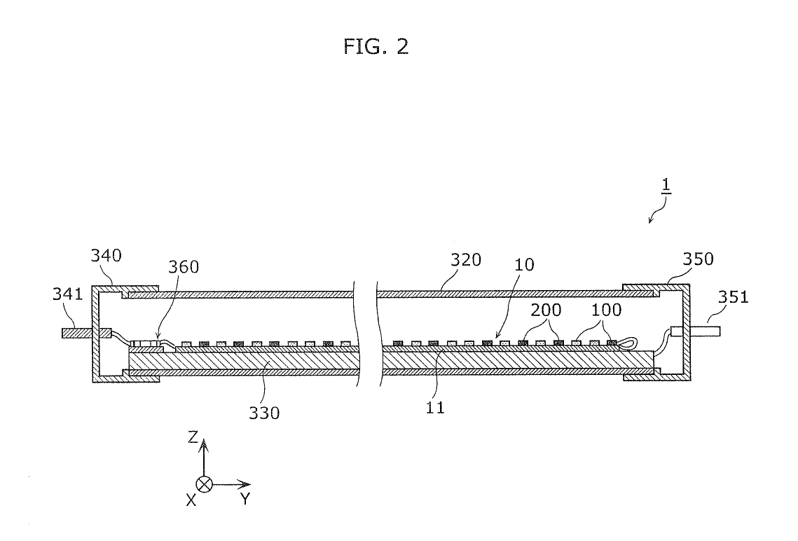

First, a configuration of the straight tube LED lamp 1 according to this embodiment of the present invention is described with reference to FIG. 1 and FIG. 2.

FIG. 1 is a general perspective view of a straight tube LED lamp according to this embodiment. FIG. 2 is a cross-sectional view in a tube axis direction of the straight tube LED lamp according to this embodiment. As shown in FIG. 1, the straight tube LED lamp 1 is a lighting source including: an LED module 10; an elongated case 320 that houses the LED module 10; a base platform 330; a feeding base (feeding-side base) 340 provided to one of end portions in a longitudinal direction (tube axis direction) of the case 320; a non-feeding base 350 provided to the other of the end portions in the longitudinal direction of the case 320; and a lighting circuit (not shown). In the straight tube LED lamp 1, the feeding base 340, the non-feeding base 350, and the case 320 constitute an elongated cylindrical lamp case (envelope). The straight tube LED lamp 1 is supported by a lighting appliance by the feeding base 340 and the non-feeding base 350 being attached to a socket of the lighting appliance with a feeding pin 341 and a non-feeding pin 351.

In the case 320, a drive circuit 360 is provided which includes: a selection control circuit that switches between connectors passing power supplied to the LED module 10 and between switch elements according to an external signal; and a constant power output circuit (not shown in FIG. 1) that supplies constant power to the LED module 10. The drive circuit 360 receives power from an external power source via the feeding pin 341. The constant power output circuit supplies constant power to an LED array selected by the selection control circuit. With this, the straight tube LED lamp 1 emits light having an emission color of the selected LED array.

The straight tube LED lamp 1 adopts a one-side feeding system in which only the feeding base 340 feeds power to the LED module 10. In other words, the straight tube LED lamp 1 receives power from the lighting appliance or the like via only the feeding base 340.

The following describes in detail each structural element of the straight tube LED lamp 1.

### [Case]

The case 320 is an elongated translucent cover covering the LED module 10 and having translucency. In this embodiment, as shown in FIG. 1, the case 320 is a straight outer tube having openings at the both end portions and including an elongated cylinder. The case 320 can be made of a transparent resin material or glass.

Examples of the case 320 as a straight tube include a glass tube made of soda-lime glass 70 to 72[%] of which is silica (SiO₂) and having a thermal conductivity of approximately 1.0 [W/m·K]. The examples also include a plastic tube made of a resin material such as acrylic and polycarbonate.

Diffusion treatment on an outer surface or an inner surface of the case 320 allows diffusion of light from the LED module 10. Examples of the diffusion treatment include a method for applying silica, calcium carbonate, or the like to the inner surface of the case 320 such as a glass tube.

It is to be noted that the case 320 may include a light diffusion unit having a light diffusion function to diffuse light from the LED module 10. With this, the light emitted from the LED module 10 can be diffused when passing through the case 320. Examples of the light diffusion unit include a light diffusion sheet or a light diffusion film provided to at least one of the inner surface and the outer surface of the case 320. Specifically, the examples include a semi-opaque light diffusion film formed by attaching, to at least one of the inner surface and the outer surface of the case 320, resin containing light diffusion materials (fine particles) such as silica and calcium carbonate, and white pigment. Other examples of the light diffusion unit include a lens structure provided to at least one of an inner portion and an outer portion of the case 320, and a recess or a projection provided to at least one of the inner surface and the outer surface of the case 320. For instance, printing a dot pattern on at least one of the inner surface and the outer surface of the case 320 or processing part of the case 320 gives the light diffusion function (light diffusion unit) to the case 320. Moreover, casting the case 320 itself with a resin material in which light diffusion materials are dispersed or the like gives the light diffusion function (light diffusion unit) to the case 320.

### [Base Platform]

As shown in FIG. 1 and FIG. 2, the base platform 330 holds (supports) the LED module 10 and the drive circuit 360, and thermally connects the LED module 10 and the drive circuit 360. Moreover, the base platform 330 is firmly fixed to the inner surface of the case 320, and heat of the base platform 330 is thermally conducted to the case 320 and radiated from the outer surface of the case 320 to the outside of the lamp. A surface of the base platform 330 not in contact with the case 320 is a plate-shaped mounting part on which the LED module 10 is mounted. In this embodiment, a mounting surface of the mounting part, the front surface of the base platform 330, is an elongated rectangular flat surface.

The base platform 330 is made of, for example, a highly thermally conductive material such as metal (e.g., aluminum). It is to be noted that the base platform 330 may be made of resin. In this case, for instance, a resin material having high thermal conductivity is used.

### [Configuration of LED Module]

The LED module 10 is a lighting source module of the straight tube LED lamp 1, and is fixed to the mounting part on the front surface of the base platform 330 to be covered with the case 320 as shown in FIG. 2. There are various methods for fixing to the mounting part such as fixation with a hook, a slide, silicon, a rivet, caulking, and so on in addition to fixation with an adhesive, a screw, and so on.

As shown in FIG. 1 and FIG. 2, the LED module 10 is elongated in a tube axis direction of the case 320, and LED elements 100 and LED elements 200 that are surface mount devices (SMDs) are mounted on a board 11. As shown in the figures, the LED module 10 is a light-emitting module including: the board 11; the LED elements 100; the LED elements 200 having a different emission color from an emission color of the LED elements 100; and the drive circuit 360 including the FET switch SW2. It is to be noted that although the drive circuit 360 including the FET switch SW2 is not disposed on the board 11 in FIG. 2, the drive circuit 360 may be mounted on an end portion of the board 11. Alternatively, as shown in FIG. 2, the drive circuit 360 may be disposed inside the feeding base 340 via a lead wire connected to a connection terminal on the board 11.

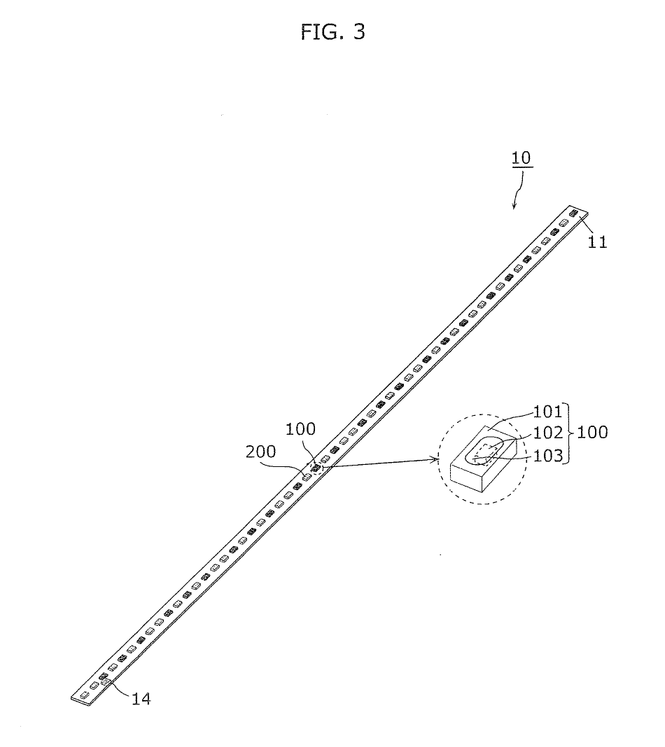

FIG. 3 is a perspective view illustrating a configuration of an LED module according to Embodiment 1. The LED module 10 shown in the figure is a structural element of the straight tube LED lamp 1 shown in FIG. 1.

In the straight tube LED lamp 1, a top surface of the base platform, an elongated rectangular flat surface, is the board 11, and the LED elements 100 and the LED elements 200 that are the SMDs are mounted on the board 11. As shown in the figure, the LED module 10 includes: the board 11; an LED array 100A including the LED elements 100; an LED array 200A including the LED elements 200 and having a different emission color from an emission color of the LED array 100A; the FET switch SW2 (not shown); and a connection terminal 14.

The LED array 200A is a first light-emitting unit including the LED elements 200 aligned on the board 11 in a longitudinal direction thereof and electrically connected in series. The LED array 100A is a second light-emitting unit including the LED elements 100 aligned on the board 11 in the longitudinal direction and electrically connected in series, and emitting light having a different emission color from an emission color of the LED array 200A. Moreover, the LED elements 100 are in alignment with the LED elements 200.

Each of the LED elements 100 that are the SMDs includes: a resin package (container) 101; an LED chip 102 mounted in a recess of the package 101; and a sealing component (phosphor-containing resin) 103 sealed in the recess. It is to be noted that the LED elements 200 that are the SMDs have the same configuration as the LED elements 100. Each of the LED elements 200 is, for instance, a first light-emitting element which includes an LED chip having a forward voltage Vf of 3 V and a sealing component including an orange phosphor (with a color temperature of 2700 K), and which emits light having incandescent color. Each of the LED elements 100 is, for instance, a second light-emitting element which includes the LED chip 102 having a forward voltage Vf of 3 V and a sealing component including a white phosphor (with a color temperature of 6500 K), and which emits light having daylight color. It is to be noted that the sealing component is made of, for instance, a translucent material such as silicon resin, and a phosphor.

Here, a first total forward voltage that is a voltage value obtained by adding a forward voltage of each and every one of the LED elements 200 connected in series is greater than a second total forward voltage that is a voltage value obtained by adding a forward voltage of each and every one of the LED elements 100 connected in series. Moreover, the forward voltages of the LED elements 200 are equal to those of the LED elements 100, and the number of the LED elements 200 connected in series is greater than the number of the LED elements 100 connected in series. In other words, the LED arrays differ in total forward voltage, and in amount of voltage drop in the case where current flows through each of the LED arrays. With this, it is possible to selectively pass current to, among current paths of current flowing through the LED arrays, a current path having a small amount of voltage drop.

The board 11 is an LED mounting board which has at least a surface including an insulating material and on which LED elements are mounted. The board 11 is an elongated board, for instance. Examples of the board 11 include a glass epoxy board (CEM-3, FR-4, and so on), a board including paper phenol or paper epoxy (FR-1 or the like), a flexible board including polyimide or the like and having flexibility, and a metal base board. Examples of the metal base board include an aluminum alloy board having an insulating film on a surface, an iron alloy board, and a copper alloy board. The front surface and the back surface of the board 11 are rectangular when viewed planarly. Moreover, to enhance reflectivity and protect wiring, a white resist may be applied to the front surface of the board 11.

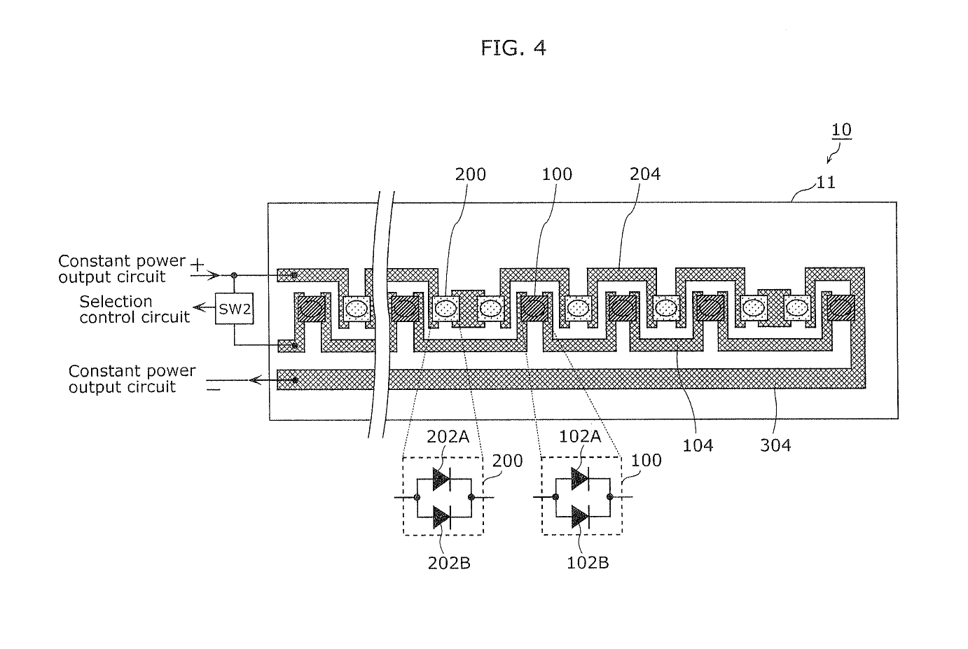

FIG. 4 is an exemplary layout view of LED elements in the LED module according to Embodiment 1. The figure shows the layout of the LED elements and wiring when the board 11 is viewed planarly.

The LED elements 100 aligned on the board 11 are connected in series by a line 104 to form the LED array 100A. The LED elements 200 aligned on the board 11 are connected in series by a line 204 to form the LED array 200A. Moreover, a cathode terminal of the LED array 100A and a cathode terminal of the LED array 200A are connected to a common line 304. The lines 104, 204, and 304 are formed on the board 11. The LED elements 100 are in alignment with the LED elements 200 according to the layout of the lines 104, 204, and 304.

The connection terminal 14 as shown in FIG. 3 is provided to the board 11. The lines 104, 204, and 304 are connected to the connection terminal 14 and to the drive circuit 360 provided inside the feeding base 340. It is to be noted that a lead wire is soldered at the connection terminal 14 to be fixed to the board 11.

Here, in the element layout shown in FIG. 4, at lease one LED element 200 is disposed between two LED elements 100 arbitrary selected from among the LED elements 100. In this embodiment, the LED elements 200 and the LED elements 100 are arranged at an arrangement number ratio of 4:3. According to the element layout shown in FIG. 4, since the LED elements 100 having a smaller term in the arrangement number ratio are not adjacent to each other, the LED elements 200 and the LED elements 100 are alternately arranged as much as possible according to the arrangement number ratio between the LED elements 200 and the LED elements 100. Thus, for example, it is possible to adjust light distribution properties without providing a light distribution adjusting unit above the elongated board 11, and an optical mechanism can be simplified.

It is to be noted that the arrangement of the LED arrays 100A and 200A is not limited to the linear arrangement as shown in FIG. 3 and FIG. 4. The LED arrays 100A and 200A may be linearly arranged on a predetermined curve line, according to the light distribution properties or the like of the straight tube LED lamp 1, for instance.

Moreover, the front surface of the board 11 needs not be entirely flat if the LED elements can be arranged planarly. Furthermore, the back surface of the board 11 is not limited to be flat.

Here, as shown in FIG. 4, the LED elements 100 and 200 that are the SMDs may each include LED chips 102A and 102B connected in parallel and LED chips 202A and 202B connected in parallel, respectively. In this configuration, the LED element 200 includes, for example, the LED chips 202A and 202B having a forward voltage Vf of 3 V, and a sealing component including an orange phosphor (with a color temperature of 2700 K), and emits light having incandescent color. Moreover, the LED element 100 includes, for example, the LED chips 102A and 102B having a forward voltage Vf of 3 V, and the sealing component 103 including a white phosphor (with a color temperature of 6500 K), and emits light having daylight color. In the case of the configuration of the LED element shown in FIG. 4, a combined forward voltage of a set of the LED chips 102A and 102B connected in parallel and included in the LED array 100A is expressed as Vf/2. Similarly, a combined forward voltage of a set of the LED chips 202A and 202B connected in parallel and included in the LED array 200A is expressed as Vf/2. A voltage value obtained by adding a combined forward voltage of each and every one of series-connected sets of the LED chips 202A and 202B connected in parallel is a first total forward voltage. Moreover, a voltage value obtained by adding a combined forward voltage of each and every one of series-connected sets of the LED chips 102A and 102B connected in parallel is a second total forward voltage. In this relationship, the first total forward voltage is greater than the second total forward voltage. In this embodiment, the LED chips 102A, 102B, 202A, and 202B have an equal forward voltage. In this relationship, the number of the series-connected sets of the LED chips connected in parallel and included in the LED array 200A is greater than the number of the series-connected sets of the LED chips connected in parallel and included in the LED array 100A. In other words, the LED arrays differ in total forward voltage, and in amount of voltage drop in the case where current flows through each of the LED arrays. With this, it is possible to selectively pass current to, among current paths of current flowing through the LED arrays, a current path having a small amount of voltage drop.

A first current path passing through the LED array 200A bypasses the FET switch SW2, and a second current path passing through the LED array 100A passes through the FET switch SW2. With this configuration, if the FET switch SW2 is in a non-conduction state, the constant power output circuit 20 supplies power only to the LED array 200A, and if the FET switch SW2 is in a conduction state, the constant power output circuit 20 supplies power to the LED array 100A.

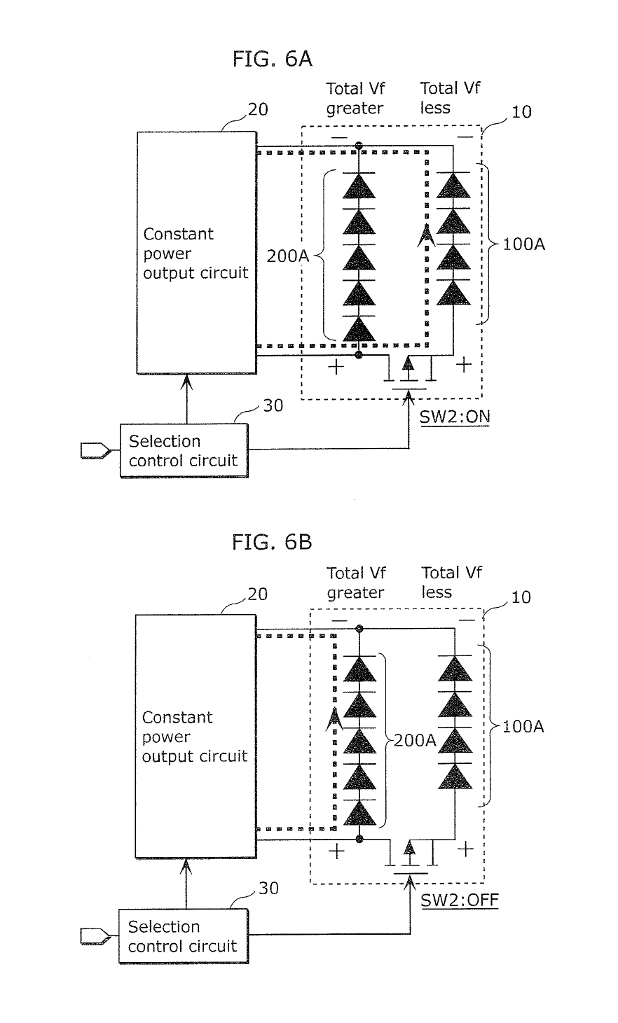

It is to be noted that although the ratio between the numbers of the LED elements 200 and the LED elements 100 is 4:3 in FIG. 2, a ratio between the numbers of LED elements is not limited to the ratio between the numbers of the LED elements 200 and the LED elements 100. The LED array 200A and the LED array 100A may differ in an emission light as a difference in configuration between the LED array 200A and the LED array 100A, and their difference in total forward voltage (hereinafter may be referred to as total Vf) obtained by serial addition of forward voltages Vf (or combined forward voltages) of respective LED chips may be a forward voltage Vf of substantially one LED chip, e.g. approximately 2.5 V or higher. This will be described later with reference to FIG. 6A and FIG. 6B.

### [Configuration of LED Lamp]

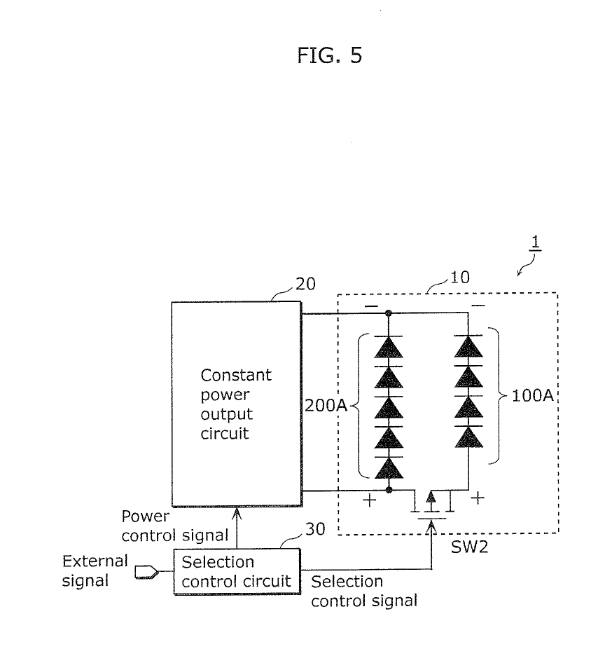

FIG. 5 is a block configuration diagram of an LED lamp according to Embodiment 1. As shown in the figure, the straight tube LED lamp 1 includes the LED module 10, the constant power output circuit 20, and a selection control circuit 30. Moreover, as shown in FIG. 3 and FIG. 4, the LED module 10 includes the LED array 100A, the LED array 200A, and the FET switch SW2.

As shown in FIG. 4, the LED array 200A is the first light-emitting unit which includes the LED elements 200 connected in series and has a first anode terminal and a first cathode terminal. The LED array 100A is the second light-emitting unit which includes the LED elements 100 connected in series, has a second anode terminal and a second cathode terminal, and emits light having a different emission color from an emission color of the first light-emitting unit. Moreover, the LED array 200A has the cathode terminal connected to the cathode terminal of the LED array 100A, and the anode terminal connected to the anode terminal of the LED array 100A via the FET switch SW2. It is to be noted that although each LED element 200 and each LED element 100 both include, for instance, the LED chips having the equal forward voltage Vf in FIG. 4, the present invention is not limited to this. The LED element 200 and the LED element 100 both do not need to include the LED chips having the equal forward voltage Vf, and may differ in an emission color as an array. In addition, the LED array 200A may have a greater total forward voltage than the LED array 100A does.

In this embodiment, for example, the LED element 200 is a first light-emitting element which includes an LED chip having a forward voltage Vf of 3 V and a sealing component containing an orange phosphor, and which emits light having incandescent color. Moreover, the LED element 100 is a second light-emitting element which includes an LED chip having a forward voltage Vf of 3 V and a sealing component containing a white phosphor, and which emits light having daylight color. Here, assuming that the LED array 200A includes 24 LED elements 200 connected in series and each having two LED chips connected in parallel, a total Vf is 36 V (=3 V/2×24). Furthermore, assuming that the LED array 100A includes 18 LED elements 100 connected in series and each having two LED chips connected in parallel, a total Vf is 27 V (=3 V/2×18).

The FET switch SW2 is a first switch element that has a source terminal and a drain terminal connected between the first anode terminal and the second anode terminal, and switches between a first current path through which current flows to the first light-emitting unit and a second current path through which current flows to the second light-emitting unit. In other words, the FET switch SW2 has the source terminal and the drain terminal that are connected in series in the second current path having a less total forward voltage out of the first current path through which current flows from the constant power output circuit 20 to the LED array 200A and the second current path through which current flows from the constant power output circuit 20 to the LED array 100A. Moreover, the FET switch SW2 has a gate terminal to which the selection control circuit 30 applies a selection control signal.

Upon receiving an external signal, the selection control circuit 30 outputs a selection control signal and a power control signal to the FET switch SW2 and the constant power output circuit 20, respectively, based on the external signal.

The FET switch SW2 is a p-type FET that switches between ON and OFF according to the selection control signal inputted to the gate terminal. This switching allows the constant output circuit 20 to supply constant power to the LED array 200A or the LED array 100A.

The constant power output circuit 20 does not change an amount of power supplied to the LED module 10 by the on/off operation of the FET switch SW2, under a certain power control signal. To put it another way, the constant power output circuit 20 outputs the same power value to one of the LED array 200A and the LED array 100A through which current flows before conduction and non-conduction of the FET switch SW2 are switched, and the other of the LED array 200A and the LED array 100A through which current flows after the switching. In contrast, the constant power output circuit 20 controls an amount of power supplied to the LED module 10, by duty adjustment based on the PWM technique, for example, according to the power control signal from the selection control circuit 30.

Stated differently, the straight tube LED lamp 1 is capable of maintaining brightness and an amount of power relative to the switching between emission colors. In addition, the straight tube LED lamp 1 also has a function to change the brightness and the amount of power according to an external (light adjustment) signal.

It is to be noted that although this embodiment has exemplified the configuration in which the two LED arrays are electrically connected in parallel and aligned, three or more LED arrays may be electrically connected in series and aligned. For instance, if an n number of LED arrays are electrically connected in parallel, each of the n number of the LED arrays may have a different total Vf, and a FET switch may be inserted in series between anode terminals of adjacent LED arrays. Note that the FET switch is not provided in a current path passing through an LED array having the greatest total Vf among the n number of the LED arrays. Stated differently, if the n number of the LED arrays are electrically connected in parallel, an (n−1) number of FET switches are necessary.

The following describes a relationship between the on/off operation of the FET switch SW2 and a current path with reference to FIG. 6A and FIG. 6B.

FIG. 6A is a state transition diagram illustrating a current path in the case where the FET switch of the LED lamp according to Embodiment 1 is in the ON state. FIG. 6B is a state transition diagram illustrating a current path in the case where the FET switch of the LED lamp according to Embodiment 1 is in the OFF state. Here, as stated above, the total forward voltage (hereinafter also referred to as a total Vf) of the LED array 200A is 36 V, the total forward voltage of the LED array 100A is 27 V, and the difference in total forward voltage is 9 V.

In the above configuration, first, if the FET switch SW 2 is in the ON state according to a selection control signal, current supplied from the constant power output circuit 20 flows through the current path passing through the LED array 100A having the less total Vf, and the LED array 100A emits light having daylight color. In other words, if the difference in total Vf between the LED arrays is greater or equal to 4 V, and the FET switch SW2 is in a conduction state, the constant power output circuit 20 supplies power only to the LED array 100A.

In contrast, in the case where the FET switch SW2 is in the OFF state according to a selection control signal, the current path passing through the LED array 200A is blocked, current supplied from the constant power output circuit 20 flows through the current path passing through the LED array 200A, and the LED array 200A emits light having incandescent color.

Here, for example, the phosphors of the LED array 200A have low luminous efficiency, and the phosphors of the LED array 100A have high luminous efficiency. To connect both the LED arrays 200A and 100A to the constant power output circuit 20 and drive the LED arrays 200A and 100A at the same illuminance, the number of the LED elements connected in series and included in each of the arrays is adjusted such as increasing the number of the LED elements of the LED array 200A having lower luminous efficiency. In this embodiment, the LED array 200A has the greater number of the LED elements connected in series, and thus the emission colors can be switched while the LED array 200A and the LED array 100A have the same illuminance. In other words, since the LED array 200A having the lower luminous efficiency includes more LED elements, and the LED elements 100 having the smaller term in the arrangement number ratio are not adjacent to each other, the LED elements 200 and the LED elements 100 are alternately arranged as much as possible according to the arrangement number ratio between the LED elements 200 and the LED elements 100.

In the case where the current flows through the above two current paths, and even if the FET switch SW2 switches between the current paths in a situation where the power control signal is constant, the constant power output circuit 20 is capable of providing the same power value to the LED array 200A and the LED array 100A.

Furthermore, since a circuit element that switches between the current paths of the LED arrays is only the FET switch SW2, it is possible to reduce the number of circuit components, and switch between the emission colors without changing the brightness and the power consumption.

It is to be noted that if the total Vf of the LED array 200A is greater than the total Vf of the LED array 100A by at least 4 V in the state transition of FIG. 6A, it is possible to pass the current to the LED array 100A completely.

In contrast, if the total forward voltage of the LED array 200A is greater than the total forward voltage of the LED array 100A by at least 2 V but less than 4 V, since current dominantly flows through the LED array 100A while very little current flows through the LED array 200A, it is possible to mix the emission colors. To put it another way, in the case where the FET switch SW2 is in the conduction state, the constant power output circuit 20 supplies main power to the LED array 100A, and power less than the main power to the LED array 200A. In this case, the constant power output circuit 20 outputs power to the LED array 200A and the LED array 100A without changing a total value of power supplied to the LED array 200A and the LED array 100A between before and after conduction and non-conduction of the FET switch SW2 are switched.

### [Circuit Configuration of LED Lamp]

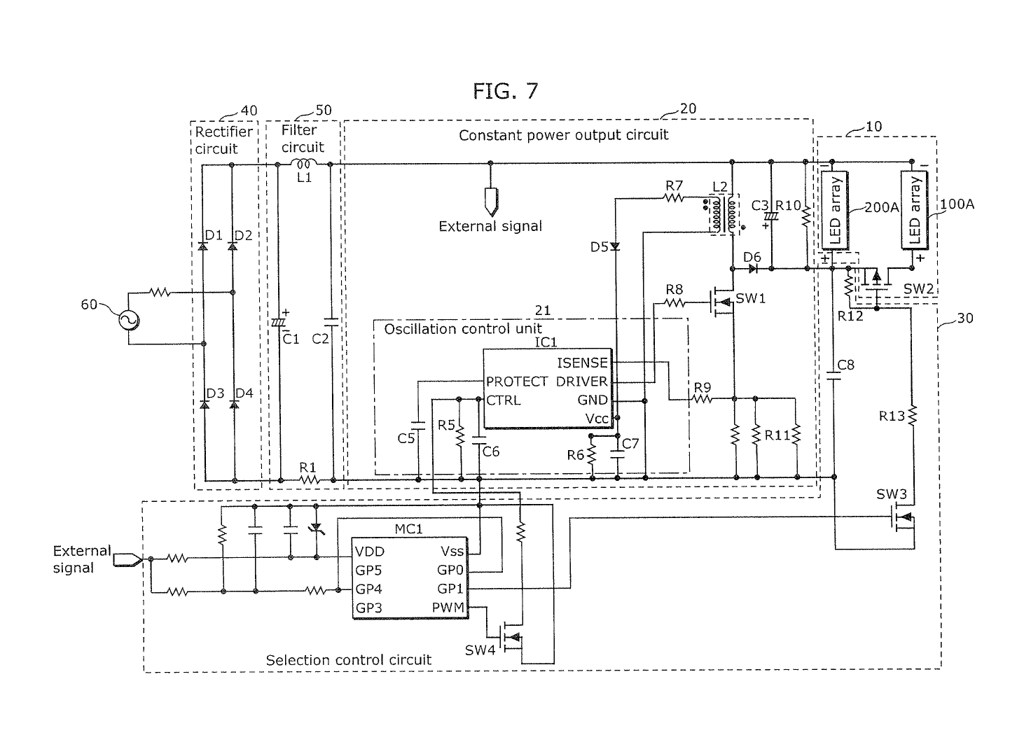

Next, the circuit configuration of the straight tube LED lamp 1, and especially the circuit configuration of the constant power output circuit 20, are described with reference to FIG. 7.

FIG. 7 is a block configuration diagram of the LED lamp according to Embodiment 1. FIG. 7 illustrates the LED module 10, the constant power output circuit 20, the selection control circuit 30, a rectifier circuit 40, a filter circuit 50, and an alternating-current (AC) source 60. The constant power output circuit 20, the selection control circuit 30, the rectifier circuit 40, and the filter circuit 50 constitute a drive circuit that drives the LED module 10. The LED lamp 2 includes the drive circuit and the LED module 10.

The AC source 60 outputs, for instance, alternating current having a voltage effective value of 100 V.

The rectifier circuit 40 includes, for example, a diode bridge having four diodes D1 to D4.

The filter circuit 50 smoothes current rectified by the rectifier circuit 40, using an electrolytic capacitor C1, and filters the smoothed current into a predetermined frequency.

The constant power output circuit 20 includes a buck-boost circuit in which a primary coil of a transformer L2 is connected in parallel to the LED arrays 200A and 100A and a FET switch SW1 is connected in series to the primary coil of the transformer L2. The current supplied to the constant power output circuit 20 via the rectifier circuit 40 and the filter circuit 50 is stored as magnetic energy in the transformer L2. Moreover, the constant power output circuit 20 releases the magnetic energy stored in the transformer L2 to the LED module 10 with predetermined timing.

The selection control circuit 30 includes a microcontroller MC1 and FET switches SW3 and SW4. For instance, upon receiving an external signal for causing the LED array 100A to emit light, the microcontroller MC1 outputs a selection control signal for turning the FET switch SW3 ON, to a gate of the FET switch SW3. With this, the FET switch SW3 is turned ON, a gate voltage of the FET switch SW2 of p-type is pulled down, and the FET switch SW2 is turned ON. Thus, the current supplied to the LED module 10 selectively flows through the current path passing through the LED array 100A. In contrast, upon receiving an external signal for causing the LED array 200A to emit light, the microcontroller MC1 outputs a selection control signal for turning the FET switch SW3 OFF, to the gate of the FET switch SW3. With this, the FET switch SW3 is turned OFF, a gate voltage of the FET switch SW2 of p-type changes to a high level, and the FET switch SW2 is turned OFF. Thus, the current supplied to the LED module 10 selectively flows through the current path passing through the LED array 200A.

In addition to the above, for example, upon receiving an external signal for varying the brightness (illuminance) of the LED module 10, the microcontroller MC1 outputs a signal for controlling an on/off operation of the FET switch SW3, to a gate of the FET switch SW4. With this, the FET switch SW4 is turned ON or OFF at predetermined intervals, and thus an output control signal for controlling an oscillation frequency of the FET switch SW1 is provided to IC1 of an oscillation control unit 21.

In other words, the FET switch SW3 is a switch element for switching between emission colors, and the FET switch SW4 is a switch element for switching between illuminance.

### [Configuration and Operation of Constant Power Output Circuit]

The constant power output circuit 20 includes the transformer L2, the FET switch SW1, a diode D6, a resistor R9, and the oscillation control unit 21. The oscillation control unit 21 includes the IC1 that controls conduction and non-conduction of the FET switch SW1. The following describes a connection relationship of each of the structural elements.

The primary coil of the transformers L2 has a high potential terminal connected to a drain terminal of the FET switch SW1. The constant power output circuit 20 connected to the rectifier circuit 40 and the filter circuit 50 has a positive input terminal connected to a low potential terminal of the primary coil of the transformer L2 (a negative output terminal of the constant power output circuit 20). The FET switch SW1 has a source terminal connected via a resistor R11 to a negative input terminal of the constant power output circuit 20 connected to the rectifier circuit 40 and the filter circuit 50. The resistor R9 is inserted in series between the source terminal of the FET switch SW1 and an ISENSE terminal of the IC1. A secondary coil of the transformer L2 supplies a power supply voltage Vcc of the IC1 via a resistor R7 and a diode D5. The primary coil of the transformer L2 has the high potential terminal connected to an anode terminal of the diode D6, and the diode D6 has a cathode terminal (a positive output terminal of the constant power output circuit 20) connected to the anode terminal of the LED array 200A. The primary coil of the transformer L2 has the low potential terminal connected to the cathode terminal of the LED array 200A. It is to be noted that in this embodiment the transformer L2 has inductance of 0.8 mH, for example.

To put it another way, the primary coil of the transformer L2 is an inductor that is connected in parallel to the LED array 200A and in parallel to a series-connected portion of the LED array 100A and the FET switch SW2. The FET switch SW1 is a second switch element connected in series to the transformer L2 between the positive input terminal and the negative input terminal of the constant power output circuit 20. The constant power output circuit 20 has the negative output terminal connected to the cathode terminals of the LED arrays 200A and 100A, and the positive output terminal connected to the anode terminal of the LED array 200A and the FET switch SW2. The constant power output circuit 20 outputs the same power value to the LED array 200A and the LED array 100A through which the current flows before and after the conduction and the non-conduction of the FET switch SW2 are switched.

The following describes in detail a relationship between switching operation of the FET switches SW1 and SW2 and light-emitting operation of the LED module 10 in the above circuit configuration.

First, the FET switch SW2 is in the OFF state at time to. Moreover, the FET switch SW1 is in the ON state, and current rectified and smoothed by the rectifier circuit 40 and the filter circuit 50 flows through the transformer L2 (primary side), the FET switch SW1, and the resistor R11. Meanwhile, magnetic energy stored in the transformer L2 increases due to power supply from a power source. At this time, the IC1 monitors the current flowing through the transformer L2, using the resistor R9. Moreover, since the cathode terminals of the LED arrays 200A and 100A are connected to the positive input terminal (negative output terminal) of the constant power output circuit 20, the current does not flow through the LED arrays 200A and 100A when the transformer L2 is charged as above.

Next, when the current flowing through the transformer L2 reaches a predetermined current value, the IC1 turns the FET switch SW1 OFF at time t1. At this time, the power supply from the power source is cut off, the magnetic energy stored in the transformer L2 is released to a current path from the transformer L2 (primary side) to the diode D6 to the LED array 200A to the transformer L2 (primary side), and the LED array 200A emits light.

Next, the IC1 turns the FET switch SW1 ON at time t2. With this, the power supply from the power source to the transformer L2 is started, the magnetic energy stored in the transformer L2 increases, and the LED array 200A stops emitting the light.

The IC1 determines, based on a power control signal from the selection control circuit 30, a duty cycle that is a ratio between an ON period (t0 to t1) and an OFF period (t1 to t2) of the FET switch SW1, and controls the FET switch SW1 using pulse-width modulation. Constant power is supplied to the LED module 10 by repeatedly turning the FET switch SW1 ON and OFF according to the duty cycle, and the LED module 10 emits light at predetermined illuminance. Here, power corresponding to the magnetic energy stored in the transformer L2 is supplied to the LED array 200A in a period when the FET switch SW2 is in the OFF state. It is to be noted that in this embodiment the FET switch SW1 has a switching frequency of 66.5 kHz, for instance.

Next, an external signal for switching between emission colors is inputted to the selection control circuit 30 at time t3. At this time, the FET switch SW3 changes to the ON state, and thus the FET switch SW2 changes to the ON state.

Next, when the current flowing through the transformer L2 reaches a predetermined current value, the IC1 turns the FET switch SW1 OFF at time t4. At this time, the power supply from the power source is cut off, the magnetic energy stored in the transformer L2 is released to a current path from the transformer L2 (primary side) to the diode D6 to the LED array 100A to the transformer L2 (primary side), and the LED array 100A emits light.

Next, the IC1 turns the FET switch SW1 ON at time t5. With this, the power supply from the power source to the transformer L2 is started, the magnetic energy stored in the transformer L2 increases, and the LED array 100A stops emitting the light.

Between the time t3 and the time t5, the IC1 controls, based on the same power control signal as the power control signal in the period between the time 0 and the time t3, the FET switch SW1 with the same duty cycle as the duty cycle between the time t0 and the time t2, using pulse-width modulation. The LED module 10 is set to the same illuminance as the illuminance between the time t0 and the time t3 based on the duty cycle. Here, the same power as the power supplied to the LED array 200A in the period when the FET switch SW2 is in the OFF state is supplied to the LED array 100A in the period when the FET switch SW2 is in the ON state.

In other words, if the FET switch SW1 is in the conduction state, the transformer L2 is charged with the current flowing from the power source to the primary coil of the transformer L2, and if the FET switch SW1 is in the non-conduction state, the magnetic energy stored in the primary coil of the transformer L2 by the charging is released to the LED array 200A or the LED array 100A. Moreover, by arranging a capacitor C3 in parallel to the LED array 200A, it is possible to smooth the current flowing through the LED array, and reduce a variation in optical output.

In the above configuration and operation, the straight tube LED lamp 1 according to this embodiment uses the constant power output circuit instead of a constant current circuit used as a drive circuit of the conventional lighting source, and thus the power corresponding to only the predetermined amount of the magnetic energy stored in the transformer L2 is supplied to the LED array. Therefore, even if amounts of voltage drop of the current paths provided to the LED module 10 differ, the power supplied to each LED array is constant.

It is to be noted that according to the constant power output circuit 20 that is buck-boost, the magnetic energy is continuously stored during the period when the FET switch SW1 is ON, and thus it is possible to sufficiently supply power to an LED array having a greater total forward voltage.

It is to be noted that although the FET switch SW2 is disposed on a high potential side of the LED arrays 200A and 100A in the circuit configuration of the LED module 10, the FET switch SW2 may be disposed on a low potential side of the LED arrays 200A and 100A.

It is to be noted that although the drive circuit included in the straight tube LED lamp 1 uses the FET as the switch element in this embodiment, the drive circuit may use a bipolar transistor.

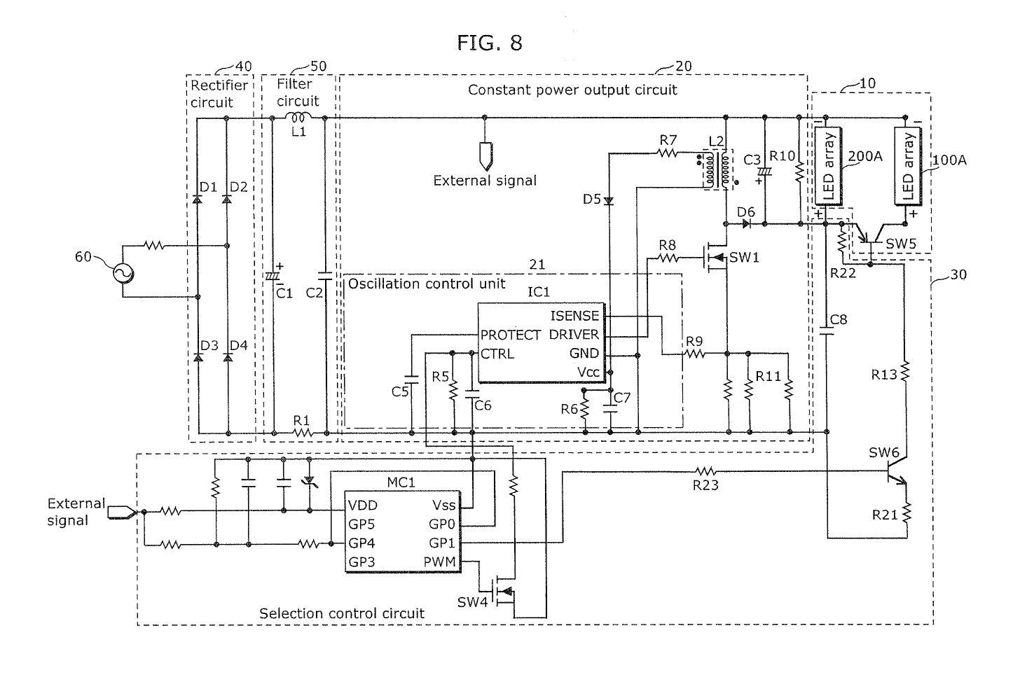

FIG. 8 is a circuit configuration diagram including an LED lamp according to a modification of Embodiment 1. A configuration of a drive circuit illustrated in FIG. 8 differs from the configuration of the drive circuit illustrated in FIG. 7 in that a PNP bipolar transistor SW5 instead of the FET switch SW2 is provided as a switch element of the LED module 10 and in that an NPN bipolar transistor SW6 instead of the FET switch SW3 is provided as a switch element of the selection control circuit 30.

For instance, upon receiving an external signal for causing the LED array 100A to emit light, the microcontroller MC1 outputs a selection control signal for passing a base-emitter current of the bipolar transistor SW6, to a base of the bipolar transistor SW6. With this, the bipolar transistor SW6 is turned ON, and an emitter-base current of the PNP bipolar transistor SW5 and an emitter-collector current of the bipolar transistor SW flow due to a collector-emitter current of the bipolar transistor SW6. Thus, the current supplied to the LED module 10 selectively flows through the current path passing through the LED array 100A. In contrast, upon receiving an external signal for causing the LED array 200A to emit light, the microcontroller MC1 outputs a selection control signal for turning the bipolar transistor SW6 OFF, to the base of the bipolar transistor SW6. With this, the bipolar transistor SW6 is turned OFF, and the bipolar transistor SW5 is also turned OFF. Thus, the current supplied to the LED module 10 selectively flows through the current path passing through the LED array 200A.

As described above, in the straight tube LED lamp 1 according to this embodiment, (1) among the two LED arrays each having the different emission color, the LED array 200A having the greater number of the LED elements connected in series has the greater total forward voltage, (2) the first switch element switches between the current paths of the LED arrays, and (3) the constant power output circuit 20 supplies the constant power to the LED array. With this, it is possible to switch between the emission colors without changing the brightness and the power consumption. Moreover, since the LED elements included in the two LED arrays are aligned, the straight tube LED lamp 1 is capable of switching the emission colors without changing the light distribution properties. Furthermore, the optical mechanism for light distribution adjustment can be simplified.

### Embodiment 2

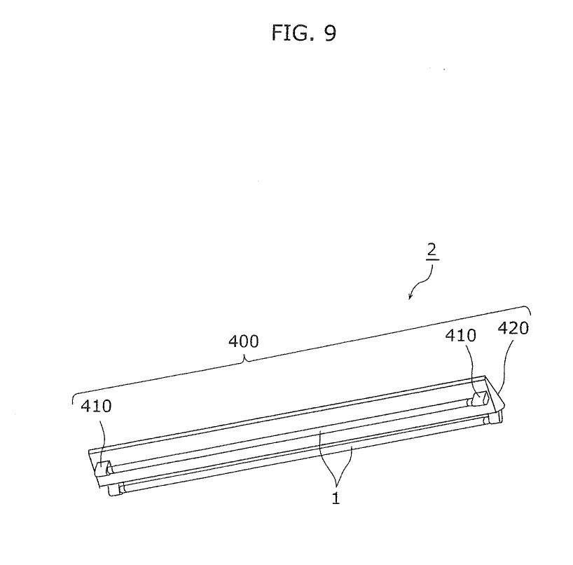

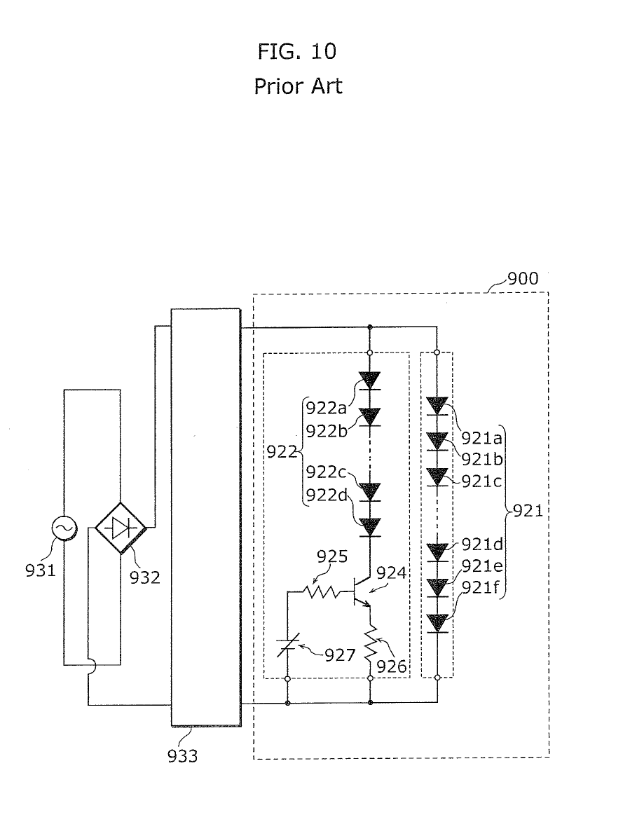

The following describes a lighting apparatus 2 according to Embodiment 2 of the present invention with reference to FIG. 9.

FIG. 9 is a general perspective view of a lighting apparatus according to Embodiment 2. As shown in the figure, the lighting apparatus 2 according to this embodiment is a base light and includes straight tube LED lamps 1 and a lighting appliance 400.

Each of the straight tube LED lamps 1 is the straight tube LED lamp 1 according to Embodiment 1, and is used as a lighting source of the lighting apparatus 2. It is to be noted that two straight tube LED lamps 1 are used in this embodiment.

The lighting appliance 400 includes: pairs of sockets 410 electrically connected to and holding the straight tube LED lamps 1; and an appliance body 420 to which the sockets 410 are attached. The appliance body 420 can be formed by press working an aluminum steel sheet, for instance. Moreover, the inner surface of the appliance body 420 is a reflective surface that reflects light emitted from the straight tube LED lamps 1 in a predetermined direction (e.g., downward).

The lighting appliance 400 thus configured is attached to a ceiling or the like via a fixture, for example. It is to be noted that the lighting appliance 400 may include a circuit for controlling lighting of the straight tube LED lamps 1. Moreover, a cover component may be provided to cover the straight tube LED lamps 1.

### Others

Although the lighting source and the lighting apparatus according to one aspect of the present invention have been described based on Embodiments 1 and 2, the present invention is not limited to these embodiments. The herein disclosed subject matter is to be considered descriptive and illustrative only, and the appended Claims are of a scope intended to cover and encompass not only the particular embodiments disclosed, but also equivalent structures, methods, and/or uses.

Moreover, although the packaged LED elements that are the SMDs are used as the LED module in Embodiment 1, the present invention is not limited to this. For instance, a chip-on-board LED module having LED chips directly mounted on a mounting board and collectively sealed with a phosphor-containing resin (sealing component) may be the LED module.

Furthermore, although, for example, the LED elements connected in series are assumed as the configuration of each LED array in Embodiment 1, the LED array may include one LED element. In this case, however, it is required that the LED elements each have a different forward voltage and different light-emitting characteristics.

Moreover, although the drive circuit 360 including the constant power output circuit 20 is disposed inside the feeding base 340 in Embodiment 1, the constant power output circuit 20 may be disposed in the lighting appliance.

Furthermore, although the LED array which emits the light having the daylight color and the LED array which emits the light having the incandescent color are switched in the above embodiments, the present invention is not limited to this. For instance, three LED arrays which respectively emit red light, green light, and blue light may be aligned and switched without changing brightness and power consumption.

Moreover, although the LED module is applied to the straight tube LED lamp in the embodiments, the present invention is not limited to this. For example, the LED module may be also applied to a ceiling light and a halogen lamp.

Furthermore, although the lighting apparatus 2 includes the two straight tube LED lamps 1, the lighting apparatus 2 may include one straight tube LED lamp 1 or at least three straight tube LED lamps 1.

The circuit configurations in the above circuit diagrams are shown as examples. The present invention is not limited to the examples. More specifically, the present invention also includes a circuit which achieves the characteristic functions of the present invention in the similar manner to the above circuit configurations. For example, the present invention includes a circuit in which an element is connected to another element such as a transistor, a resistive element, a capacitive element, and an inductive element in series or in parallel, in a range which allows the functions similar to those of the above circuit configurations. In other words, the expression “is (are) connected” in the above embodiments is not limited to the case where two terminals (nodes) are directly connected, but also includes the case where the two terminals (nodes) are connected via an element in a range which allows the similar functions.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A lighting source comprising:
an elongated board;
a first light-emitting unit including a plurality of first light-emitting elements aligned on the elongated board in a longitudinal direction thereof and electrically connected in series;
a second light-emitting unit including a plurality of second light-emitting elements aligned on the elongated board in the longitudinal direction, electrically connected in series, and emitting light having an emission color different from an emission color of the first light-emitting unit;
a first switch element provided in a second current path among a first current path and the second current path, the first current path being a path through which current flows to the first light-emitting unit, and the second current path being a path through which current flows to the second light-emitting unit; and
a constant power output circuit that outputs power to the first light-emitting unit and the second light-emitting unit without changing a total value of the power supplied to the first light-emitting unit and the second light-emitting unit between before and after conduction and non-conduction of the first switch element are switched,
wherein the number of the plurality of first light-emitting elements connected in series is greater than the number of the plurality of second light-emitting elements connected in series,
a first total forward voltage is greater than a second total forward voltage, the first total forward voltage being a voltage value obtained by adding a forward voltage of each and every one of the plurality of first light-emitting elements connected in series, and the second total forward voltage being a voltage value obtained by adding a forward voltage of each and every one of the plurality of second light-emitting elements, and
the plurality of first light-emitting elements are in alignment with the plurality of second light-emitting elements.

2. The lighting source according to claim 1,
wherein at least one of the plurality of first light-emitting elements is disposed between two light-emitting elements arbitrarily selected from among the plurality of second light-emitting elements.

3. The lighting source according to claim 1,
wherein the forward voltage of each of the plurality of first light-emitting elements is equal to the forward voltage of each of the plurality of second light-emitting elements,
each of the plurality of first light-emitting elements and each of the plurality of second light-emitting elements include, on respective surfaces thereof, phosphors different from each other, and
the first light-emitting unit has lower luminous efficiency than the second light-emitting unit does.

4. The lighting source according to claim 3,
wherein an amount of light emission of the first light-emitting unit is equal to an amount of light emission of the second light-emitting unit.

5. The lighting source according to claim 1,
wherein the first switch element is connected in series either one of between a first anode terminal of the first light-emitting unit and a second anode terminal of the second light-emitting unit and between a first cathode terminal of the first light-emitting unit and a second cathode terminal of the second light-emitting unit, and
the constant power output circuit has a negative output terminal connected to the first cathode terminal and either one of the second cathode terminal and the first switch element connected to the second cathode terminal, and a positive output terminal connected to the first anode terminal and either one of the second anode terminal and the first switch element connected to the second anode terminal.

6. The lighting source according to claim 1,
wherein the first current path bypasses the first switch element,
the second current path passes through the first switch element,
if the first switch element is in a non-conduction state, the constant power output circuit supplies the power only to the first light-emitting unit among the first light-emitting unit and the second light-emitting unit, and
if the first switch element is in a conduction state, the constant power output circuit supplies main power to the second light-emitting unit.

7. The lighting source according to claim 6,
wherein the first total forward voltage and the second total forward voltage have a difference of at least 4 V, and
if the first switch element is in the conduction state, the constant power output circuit supplies the power only to the second light-emitting unit among the first light-emitting unit and the second light-emitting unit.

8. The lighting source according to claim 6,
wherein the first total forward voltage and the second total forward voltage have a difference of at least 2 V but less than 4 V, and
if the first switch element is in the conduction state, the constant power output circuit supplies the main power to the second light-emitting unit, and power less than the main power to the first light-emitting unit.

9. The lighting source according to claim 1,
wherein the constant power output circuit includes:
an inductor that is connected in parallel to the first light-emitting unit and in parallel to a series-connected portion of the second light-emitting unit and the first switch element;
a second switch element connected in series to the inductor between a positive input terminal and a negative input terminal of the constant power output circuit; and
an oscillation control unit configured to control conduction and non-conduction of the second switch element,
if the second switch element is in a conduction state, the inductor is charged with current flowing from a power source to the inductor, and
if the second switch element is in a non-conduction state, magnetic energy stored in the inductor by the charging is released to either one of the first light-emitting unit and the second light-emitting unit.

10. The lighting source according to claim 1,
wherein the first light-emitting unit has an emission color that is incandescent color, and
the second light-emitting unit has an emission color that is daylight color.

11. A lighting apparatus comprising the lighting source according to claim 1.
